(19) United States
(12) Patent Application Publication
(10) Pub. No.: US 2018/0343355 A1
(43) Pub. Date: Nov. 29, 2018

(54) IMAGE FORMING APPARATUS THAT USES A REMOVABLE STORAGE MEDIUM

(71) Applicant: KYOCERA Document Solutions Inc., Osaka (JP)

(72) Inventor: Shinichi OMOYA, Osaka (JP)

(73) Assignee: KYOCERA Document Solutions Inc., Osaka (JP)

(21) Appl. No.: 15/989,381

(22) Filed: May 25, 2018

(30) Foreign Application Priority Data
May 25, 2017 (JP) 2017-103530

(51) Int. Cl. H04N 1/00; G06F 3/12

(52) U.S. Cl. CPC H04N 1/00896; H04N 1/00904; G06F 3/1229; G06F 3/1221; H04N 1/0044

(57) ABSTRACT

Provided is an image forming apparatus in which a removable storage medium is used, and is an image forming apparatus that is capable of achieving both reduced power consumption and efficient operation. The image forming apparatus has a storage-medium-recognizing unit for recognizing whether or not the storage medium is connected. When the storage-medium-recognizing unit recognizes that the storage medium has been connected while the supply of electric power to a printing-executing unit is stopped in a standby state, electric power is supplied to an operation-receiving unit. After electric power is supplied to the operation-receiving unit, when there is an operation indicating that the printing-executing unit is used, electric power is supplied to the printing-executing unit.

### INCORPORATION BY REFERENCE

This application is based on and claims the benefit of priority from Japanese Patent Application No. 2017-103530 filed on May 25, 2017, the contents of which are hereby incorporated by reference.

### BACKGROUND

The present disclosure relates to an image forming apparatus that uses a removable storage medium.

Many electrical devices are set to a standby mode (for example a standby mode, ready mode, and the like) in a standby state in which the electric power switch is ON however the device is not in operation. In the standby mode, in order to reduce power consumption, electric power is supplied only to the minimum necessary components such as a display unit and the like in order that operation by the user is possible, and electric power is not supplied to components that are not operating. Furthermore, in order to reduce power consumption in a standby state, the display unit and the like are also set to an operating mode in which electric power is not supplied (for example, power-saving mode, sleep mode, and the like). A switch or the like makes it possible to switch between a printing mode that executes printing and in which electric power is supplied to all of the components, and a standby mode, power-saving mode and the like in this kind of standby state.

For example, in an image forming apparatus that prints an image on paper and outputs the paper, in order to actually perform a mechanical operation of transferring a toner pattern to paper and fixing that toner pattern, a mechanical mechanism that uses a motor is used. Moreover, it is necessary that the temperature of a fixing roller that is used for fixing the toner be at a high temperature within a fixed range, so an electric heater is also used. Therefore, power consumption during operation of a printing mechanism that performs this kind of operation is particularly large. In the standby mode or power-saving mode, by supplying electric power to a CPU and the like that performs overall control of the apparatus, and not supplying electric power to the printing mechanism, power consumption can be greatly reduced.

However, in order to perform a printing operation it is necessary to supply electric power to the printing mechanism. Therefore, when the CPU receives an instruction for a printing operation when the image forming apparatus is in the standby mode or the power-saving mode, the CPU automatically supplies electric power to the printing mechanism, or by switching to a printing mode, can cause this printing operation to be performed. However, a fixed amount of time is required from the time that electric power is supplied to the heater of the fixing roller until the temperature of the fixing roller becomes stable, so when performing a printing operation from a standby state or state of the power-saving mode, it takes time for the printing mode to be set.

Moreover, in an image forming apparatus, image data (printing data) that is to be outputted can be received from a computer that is connected via a network, for example. However, there are also cases in which printing is performed using data (document file) that is stored on a removable storage medium (USB memory and the like). The case will be explained in which in a typical image forming apparatus, a storage medium is connected when in the power-saving mode. In this case, by determining that a printing operation will be performed thereafter using this data, and automatically changing from the standby mode or power-saving mode to the printing mode (electric power is supplied to the printing mechanism), the printing operation thereafter can be performed quickly.

Furthermore, when the image forming apparatus is a multifunction peripheral (MFP), for example, the image forming apparatus may also include not only a printing function such as described above, but also a FAX function and scanning function (function that optically reads and saves a document as image data). When using the scanner function, a copying function for performing a print out using the read image data can also be executed. In this case, the connected recording medium is not limited to the purpose of performing a printing operation such as described above, but is used for various purposes. For example, when using the scanner function of an image forming apparatus, image data that is read may be stored on this storage medium without performing printing. In this case, the user can remove the storage medium after that, connect this storage medium to a computer that is separate from this image forming apparatus, and use the acquired image data.

In a typical image forming apparatus as described above, when it is determined that there is no possibility that printing work will be performed using this storage medium, control is also possible so that an operation of supplying electric power to the printing mechanism is not performed. In this case, when the storage medium is connected in a state of the standby mode or the power-saving mode, the storage medium is searched, and it is determined whether or not there is data in the storage medium. When it is recognized that there is data, it is determined that printing will be performed from that data thereafter, and electric power is supplied to the printing mechanism. In this case, when a printing operation is executed thereafter, a reasonable amount of time has elapsed since the electric power started to be supplied to the printing mechanism, so printing can be performed quickly.

However, when it is recognized that there is no data in the storage medium, it is determined that a printing operation using this storage medium will not be performed thereafter, and it is presumed, for example, that image data read by a scanning function is stored in this storage medium. In this operation, the printing operation is not used thereafter, so a state in which electric power is not supplied to the printing mechanism is maintained.

In other words, with this kind of configuration, in an image forming apparatus in which a standby mode or a power-saving mode is set, after the storage medium is connected in the standby mode or power-saving mode, efficient operation can be performed while reducing power consumption.

### SUMMARY

The image forming apparatus according to the present disclosure includes a printing-executing unit and an operation-receiving unit. The printing-executing unit performs a mechanical operation for forming images on paper. The operation-receiving unit receives operations by a user. The image forming apparatus is capable of forming the images according to data that is stored in the removable storage medium, and performs control for stopping the supply of electric power to the printing-executing unit and the operation-receiving unit in a standby state. The image forming apparatus includes a storage-medium-recognizing unit that recognizes whether or not the storage medium is connected. When the storage-medium-recognizing unit recognizes that the storage medium is connected while the supply of electric power to the printing-executing unit is stopped in a standby state, electric power is supplied to the operation-receiving unit. When after electric power is supplied to the operation-receiving unit and there is an operation performed using the operation-receiving unit indicating that the printing-executing unit is used, electric power is supplied to the printing-executing unit.

### BRIEF DESCRIPTION OF THE DRAWINGS

FIG. 1 is a block diagram illustrating configuration of an image forming apparatus of an embodiment according to the present disclosure.

FIG. 2 is an example of a flowchart illustrating the operation of a control unit of an embodiment according to the present disclosure.

### DETAILED DESCRIPTION

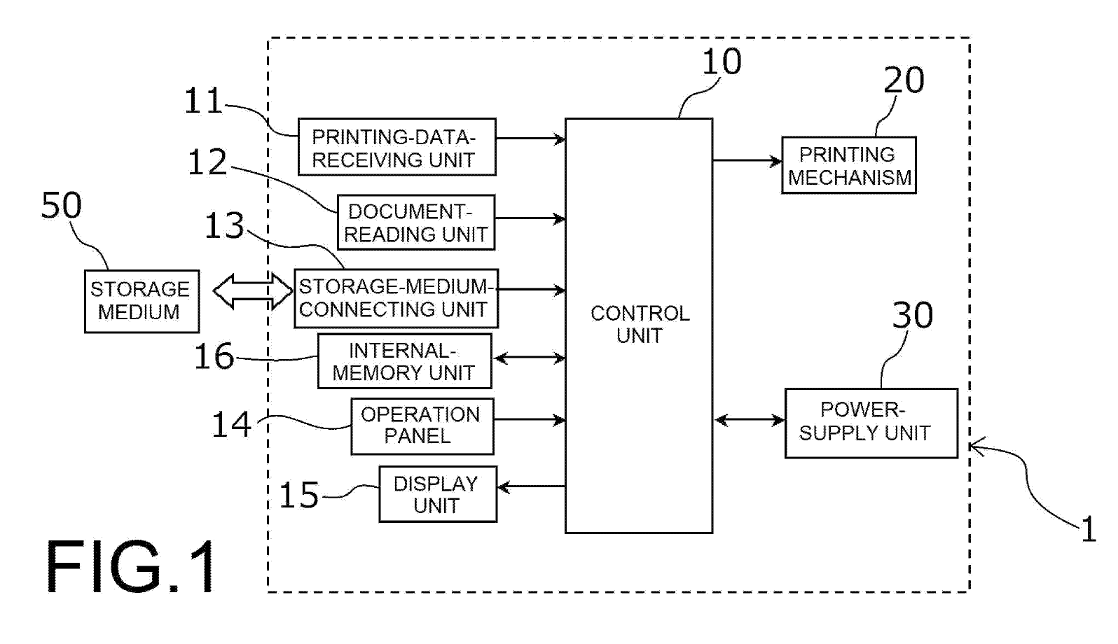

In the following, embodiments according to the present disclosure will be explained with reference to the drawings. FIG. 1 is a diagram illustrating configuration of an image forming apparatus 1 of an embodiment according to the present disclosure. This image forming apparatus 1 may be a multifunction peripheral (MFP: Multi Function Printer). This image forming apparatus 1 has a printing function of receiving printing data from a personal computer (computer) via a network, forming output based on the printing data on a medium (paper), and outputting the paper. Moreover, this image forming apparatus 1 has a scanner function of acquiring image data by optically reading an image that is recorded on paper. This image forming apparatus 1 also has a copying function of performing printing on paper based on this image data.

To achieve the printing function, the image forming apparatus 1 includes a printing-data-receiving unit 11 for acquiring printing data that is described in a page description language such as Prescribe, Postscript (both registered trademarks) and the like from a personal computer (computer) via a network. Moreover, to achieve the scanning function, the image forming apparatus 1 includes a document-reading unit 12 for acquiring two-dimensional image data, which is read from an image formed on paper by an image-capturing element .

Furthermore, a printing mechanism (printing-executing unit) 20 is used for forming an image on paper (medium) based on the printing data above-mentioned, and outputting the paper after the image is fixed. The printing mechanism 20 is mainly configured of components for performing mechanical operations. As such components, there is, for example, a photosensitive drum, a transfer roller, a fixing roller, and the like. A toner pattern that corresponds to an image to be outputted is formed on the surface of the photosensitive drum. The transfer roller transfers the toner pattern to paper by conveying paper that is sandwiched between the transfer roller and the photosensitive drum. The fixing roller fixes the toner to the paper by heating the paper after the toner image has been transferred. Moreover, in addition to these rollers, various rollers are also used for simply conveying the paper. Of the plurality of rollers such as these, at least some are driven by a motor. This motor operates by supplying electric power to the motor, and these rollers rotate in synchronization so that printing is performed properly, and so that the paper used in printing does not become slack and so that unreasonable force is not applied to the paper. In addition, in order to fix toner to the paper, high temperature is required, so a heater for maintaining high temperature is provided in the fixing roller itself. In order that the printing mechanism 20 operates properly, the temperature of the fixing roller must be maintained within a specified high-temperature temperature range, and the motor must be stably rotated and driven.

Moreover, the storage medium 50 is removable on the image forming apparatus 1. The storage medium 50 is, for example, a USB memory, and a reading operation of reading the data stored in the storage medium 50 can be performed from the image forming apparatus 1 side. This storage medium 50 is physically connected to a storage-medium-connecting unit 13 in the image forming apparatus 1. When a document file, for example, is stored in the storage medium 50, the document file can be read via the storage-medium-connecting unit 13, and printing can be performed by the printing mechanism 20 above-mentioned. In other words, this image forming apparatus 1 can acquire printing data via the storage medium 50 (storage-medium-connecting unit 13). On the other hand, it is possible, for example, to store image data that is obtained from the document-reading unit 12 above-mentioned in the storage medium 50. In this case, a user can remove the storage medium from the storage-medium-connecting unit 13 after that, and can use the storage medium by reading the storage medium by another image forming apparatus or computer.

In order to perform various operations such as these, a control unit 10 that is a CPU for performing overall control of this image forming apparatus 1 is provided. Moreover, in order to perform instructions and various settings for performing such operations, an operation panel (operation-receiving unit) 14 is provided that includes a plurality of operation keys that are operated by a user. When doing this, a display unit 15 is also provided as a display for displaying the various setting states in the image forming apparatus 1 and the contents of operations by the operation panel 14. Incidentally, a touch panel or the like integrated with the operation panel 14 and the display unit 15 may also be used.

The case will be explained in which output is performed by the printing mechanism 20 according to printing data acquired via the printing-data-receiving unit 11. In this case, when the control unit 10 recognizes that printing data is acquired in this way, the control unit 10 can cause a printing operation to be performed even without the user operating the operation panel 14. On the other hand, when the scanner function is executed, a document to be read is properly placed on the document-reading unit 12, and by a user operating the operation panel 14, operation of the document-reading unit 12 is performed, and image data is acquired. This image data is stored in an internal-storage unit 16 that is configured with a hard disk or semiconductor memory. After that, the image data can be stored in a connected storage medium 50. In this case, the printing mechanism 20 is not used at all. However, by causing the printing mechanism 20 to perform output based on this image data, the document can be copied. The user can set which operation to perform by operating the operation panel 14, and the status at that time can be confirmed on the display unit 15.

In addition, when printing a document file that is stored in a connected storage medium 50, first, the control unit 10 searches the storage medium 50 and can cause the display unit 15 to display a folder or document file that is in the storage medium 50. After that, the control unit 10 may cause the user to use the operation panel 14 to set a document file to be printed, and then execute printing.

The components of the configuration described above operate when electric power is supplied, and a power-supply unit (electric-power-supply unit) 30 is provided for supplying electric power to these components. This image forming apparatus 1 is driven by commercial AC electric power (AC 100V or the like). On the other hand, for example, the control unit 10, the display unit 15 and the like that include semiconductor circuits, operate at low DC voltage, so the AC electric power is rectified by the power-supply unit 30 and then distributed to each of the units. Moreover, the power consumption of the printing mechanism 20 that uses a motor and heater as described above is particularly high compared with the control unit 10 and the like. The power-supply 30 supplies electric power to each of the components that largely differ in power consumption in this way.

Here, the standby mode or power-saving mode is set when the image forming apparatus 1 is in a standby state, or in other words, in a state in which the main power supply is turned ON, however operation is not performed for the printing function, scanner function or copy function. In the printing mode, the power-supply unit 30 supplies electric power to all of the other components in FIG. 1. However, in the standby mode or the power-saving mode, the power-supply unit 30 does not supply electric power to the document-reading unit 12 or printing mechanism 20. Furthermore, in the power-saving mode, the power-supply unit 30 does not supply electric power to the operation panel 14 or display unit 15 either. As a result, in the standby mode or the power-saving mode, the power consumption can be greatly reduced. In this case, the motor in the printing mechanism 20 stops, and the temperature of the fixing roller approaches room temperature. In order to normally operate the printing mechanism 20 from this state, it takes time from the time that electric power is supplied to the printing mechanism 20 until the temperature of the fixing roller becomes stable at high temperature. However, even in the case of the standby mode or power-saving mode, electric power is supplied to the control unit 10, the printing-data-receiving unit 11 and the storage-medium-connecting unit 13, and these units operate in the same manner as in the printing mode.

Setting the power-saving mode and printing mode is performed by the user operating the operation panel 14. The printing mode automatically switches to the standby mode after processing such as printing ends and there is no operation by the user for a specified amount of time. Switching from the standby mode or power-saving mode to the printing mode can be automatically performed by the control unit 10. For example, when in the standby mode or the power-saving mode and the printing-data-receiving unit 11 receives printing data, the control unit 10 recognizes this and can immediately switch to the printing mode, and can cause electric power to also be supplied to the printing mechanism 20. As a result, it becomes possible after that to operate the printing mechanism 20. This operation is the same as in a typical image forming apparatus described above.

Moreover, in the power-saving mode, electric power is not supplied to the operation panel 14. However, a plurality of operation keys are provided on the operation panel 14, and when some of these operation keys are operated, electric power is automatically supplied to the operation panel 14, and the mode switches to the standby mode and it is possible to perform settings for operation to be performed after that. At this time, electric power can also be supplied to other components (display unit 15, printing mechanism 20, and the like), and the mode can be set to the printing mode.

Furthermore, in this image forming apparatus 1, switching from the standby mode or power-saving mode to the printing mode can be performed according to the connection of the storage medium 50 to the storage-medium-connecting unit 13. At this time, the control unit 10 and the storage-medium-connecting unit 13 function as a storage-medium-recognizing unit that determines whether or not the storage medium 50 is connected, and perform control according to that determination. This aspect is the same as in the typical image forming apparatus described above. However, the operation at this time differs from that of the typical image forming apparatus described above.

As described above, in the power-saving mode, electric power is not supplied to the document-reading unit 12, the operation panel 14, the display unit 15 or the printing mechanism 20. In this state, when the storage medium 50 is connected, electric power is supplied to only the display unit 15 and the operation panel 14 of these. At this time, an inquiry is performed on the display unit 15 as to whether or not a printing operation will be performed thereafter, and when the reply to the inquiry indicates that a printing operation will be performed from the operation panel 14, the control unit 10 causes electric power to be supplied to the printing mechanism 20. After that, a document file that is stored in the storage medium 50 can be printed by the printing mechanism 20. At this time, a reasonable amount of time has elapsed from when electric power is started to be supplied to the printing mechanism 20, so the printing operation can be performed quickly. Moreover, when the storage medium 50 is connected in the standby mode, similarly an inquiry is performed on the display unit 15 as to whether or not a printing operation will be performed thereafter.

On the other hand, when the reply to the inquiry indicates that a printing operation will not be performed, electric power is not supplied to the printing mechanism 20, however the supply of electric power to the operation panel 14 and the display unit 15 is maintained. In this case, a printout is not performed by this image forming apparatus 1. In this case, it is presumed that an operation will be performed after that in which data is exchanged with the storage medium 50, or in other words, data in the storage medium 50 is copied or moved to the internal-storage unit 16, or data in the internal-storage unit 16 is copied or moved to the storage medium 50. In this case, the user can perform operations using the operation panel 14 and display unit 15 to perform these operations.

Differing from the typical image forming apparatus described above, in this case, regardless of whether or not there is data in the storage medium 50, electric power is supplied to the printing mechanism 20 only when a printing operation will be performed thereafter. When performing a printing operation is not scheduled thereafter even though the storage medium 50 is connected, electric power is not supplied to the printing mechanism 20, so even in spite of not being used, wastefully supplying electric power to the printing mechanism 20 is suppressed, and thus power consumption by the overall image forming apparatus 1 can be reduced. However, when a printing operation is performed, the operation can be performed quickly.

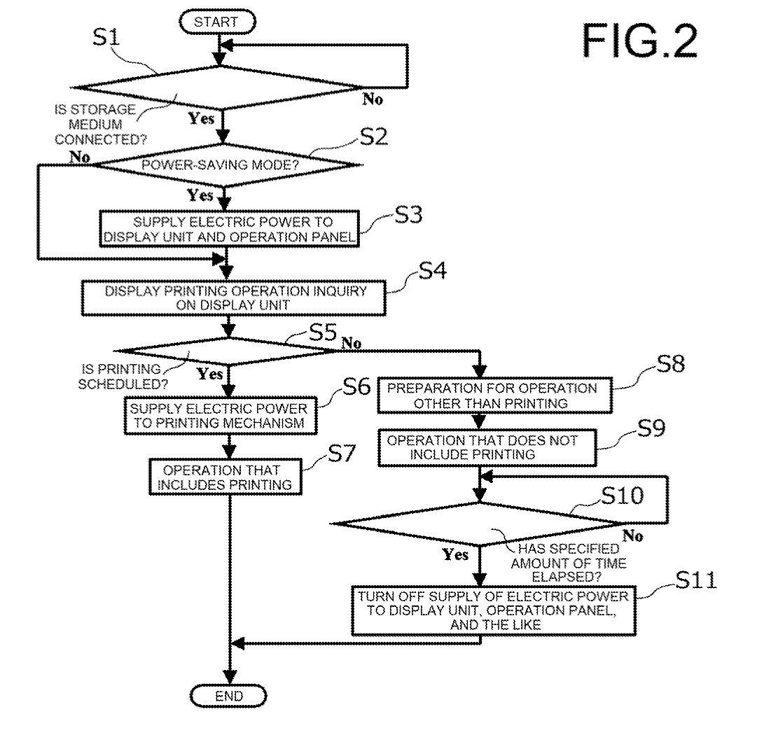

FIG. 2 illustrates an example of a flowchart of operation that is performed by the control unit 10 in the example above-mentioned. Here, the operation that is performed after the storage medium 50 is connected in the standby mode will be explained. In the standby mode, it is presumed that a standby mode or a power-saving mode such as described above is set. The operation when the storage medium 50 is not connected, or the operation that is performed regardless of whether or not the storage medium 50 is connected (for example, operation when the printing-data-receiving unit 11 receives printing data) is the same as in a typical image forming apparatus.

Here, the control unit 10 first recognizes whether or not the storage medium 50 is connected to the storage-medium-connecting unit 13 (S1). When the storage medium 50 is connected (S1: YES), the control unit 10 recognizes whether the current operating mode is the power-saving mode or the standby mode (S2).

When the current operating mode is the power-saving mode (S2: YES), at that time, as described above, electric power is not supplied to the document-reading unit 12, the operation panel 14, the display unit 15, or the printing mechanism 20. In this case, the control unit 10, while maintaining the state in which electric power is not supplied to the document-reading unit 12 or the printing mechanism 20, supplies electric power to the operation panel 14 and the display unit 15 (S3).

As a result, the control unit 10 displays a message on the display unit 15 inquiring of the user whether or not performing a printing operation is scheduled thereafter (S4), and the user can perform a reply to this inquiry via the operation panel 14 (S5). When the current mode is the standby mode (S2: NO), electric power is already being supplied to the operation panel 14 and the display unit 15, so supplying power to these units is omitted, and subsequent operation is similarly performed.

Here, when the reply to the inquiry indicates that performing a printing operation is scheduled (S5: YES), the storage medium 50 is connected, so an operation for printing and outputting a document file that is stored in the storage medium 50 can be presumed as the operation that will be performed thereafter. Therefore, the control unit 10 first supplies electric power to the printing mechanism 20 (S6), and after that can perform as scheduled an operation of printing and outputting a document file that is stored in the storage medium 50 (S7). In this case, at the time of performing this operation, a reasonable time has elapsed after electric power is supplied to the printing mechanism 20, so this operation can be performed quickly. When performing this operation, the user can use the display unit 15 and the operation panel 14.

Incidentally, electric power may be supplied to the document-reading unit 12 at the same time that electric power is supplied to the printing mechanism 20 (S6). In this case, as an operation that includes printing (S7), an operation of outputting the image data obtained by the document-reading unit 12 can be quickly performed by the printing mechanism 20. At this time, this image data can be stored in the storage medium 50.

However, when the reply to the inquiry indicates that performing a printing operation is not scheduled (S5: NO), as the operation that is to be performed thereafter, there is an operation of saving image data that is stored in the image data obtained by the document-reading unit 12, for example, in the storage medium 50 without printing and outputting the image data. Therefore, the control unit 10 performs electric power supply for performing operations that do not include printing, while maintaining a state of not supplying electric power to the printing mechanism 20 (S8). More specifically, here, electric power is supplied to the document-reading unit 12 necessary for executing the scanner function. After that, the scanner operation is performed by the user (S9). At this time, the user can operate the document-reading unit 12 or the like by performing an operation for that using the operation panel 14 and display unit 15. Incidentally, the document-reading unit 12 also requires a reasonable amount of time from when electric power is supplied until operating normally, however, a heater and the like is not used such as in the case of the printing mechanism 20, so the waiting time until normal operation is shorter than in the case of the printing mechanism 20. In this state, electric power is not supplied to the printing mechanism 20, so the power consumption by the image forming apparatus 1 can be kept small.

After that, when the operation panel 14 is not operated by the user and a preset fixed amount of time has elapsed (S10: YES), the control unit 10 again stops the supply of electric power to the operation panel 14, the display unit 15 and the document-reading unit 12 (S11). As a result, the image forming apparatus 1 is set to the power-saving mode.

In addition, in the flowchart in FIG. 2, after the printing operation (S7) has been performed when the operating mode was the power-saving mode (S2: YES), the mode is set to the printing mode. However, in this case as well, when the operation panel 14 is not operated during a preset fixed amount of time, the standby mode may be set, or the supply of electric power to the operation panel 14, the display unit 15, the document-reading unit 12 and the printing mechanism 20 may be stopped again, and the power-saving mode may be set. This is the same as in the case after other operations are performed that do not use printing (S10. S11). In this way, control for setting the power-saving mode when the printing mode is set and the waiting state becomes long can be performed regardless of whether or not the storage medium 50 is connected.

Moreover, as an operation (S7) that includes printing there is an operation of printing and outputting a document file that is stored in the storage medium 50 as described above. In order to perform this operation efficiently, first, the control unit 10 replies to the inquiry indicating that printing will be performed (S5: YES), then can search for files inside the storage medium 50 and cause the display unit 15 to display the search results. After that, the user uses the operation panel 14 and selects one of the displayed files, then by performing a setting so that the file can be printed out, performing this operation can become particularly easy.

Incidentally, in the example described above, the display unit 15 is used, and in the power-saving mode, supplying electric power to the display unit 15 is cut off. However, as long as the user can determine the next operation that is to be performed using the operation panel 14, a display unit is not necessary. For example, the contents of the corresponding operations can be clearly indicated on the operation keys themselves of the operation panel, and can be used instead of a display unit.

Moreover, in the example described above, in the power-saving mode, electric power is not supplied to the document-reading unit 12, the operation panel 14, the display unit 15 or the printing mechanism 20, however, electric power is supplied to the control unit 10, the printing-data-receiving unit 11, and the storage-medium-connecting unit 13. However, these settings are arbitrary as long as when the storage medium is connected, electric power is supplied to the operation panel so that the operation panel can be used, and after that electric power is supplied to the printing mechanism by an instruction from the operation panel. In other words, setting the supply of electric power in modes for reducing power consumption of the image forming apparatus in a standby state is arbitrary as long as the condition above-mentioned is satisfied. For example, in regard to components in FIG. 1 other than the printing mechanism 20, the control unit 10, the storage-medium-connecting unit 13, and the operation panel 14, components that have small power consumption can be supplied with electric power from the power-supply unit 30 in this mode as well. Moreover, even in the case of storage medium other than a USB memory, the same also applies when a storage medium is used having a form that allows the storage medium to be freely connected on or removed from the image forming apparatus.

Incidentally, when the image forming apparatus has particularly a lot of functions, even though there may be data in the connected storage medium, an operation of not performing printing after that using that data may be performed. Moreover, there is a possibility that this data is not related to the use of this image forming apparatus. In the typical image forming apparatus described above, in a case such as this as well, electric power is supplied to the printing mechanism that is not being unit, so wasteful power consumption occurs.

Therefore, in an image forming apparatus in which a removable storage medium is used, there is a need to achieve both a further reduction of power consumption, and more efficient operation.

With the construction described above, in an image forming apparatus in which a removable storage medium is used, a further reduction of power consumption and more efficient operation can both be achieved.

What is claimed is:

1. An image forming apparatus, comprising: a printing-executing unit for performing a mechanical operation for forming images on paper, and an operation-receiving unit for receiving operations by a user; the image forming apparatus being capable of forming the images according to data that is stored in the removable storage medium, and performing control for stopping the supply of electric power to the printing-executing unit and the operation-receiving unit in a standby state; and further comprising
a storage-medium-recognizing unit that recognizes whether or not the storage medium is connected; wherein
when the storage-medium-recognizing unit recognizes that the storage medium is connected while the supply of electric power to the printing-executing unit is stopped in a standby state, electric power is supplied to the operation-receiving unit; and
when after electric power is supplied to the operation-receiving unit and there is an operation performed using the operation-receiving unit indicating that the printing-executing unit is used, electric power is supplied to the printing-executing unit.

2. The image forming apparatus according to claim 1, further comprising a display unit that displays operation instruction for the user, and in a standby state, the supply of electric power to the display unit is stopped together with the printing-executing unit and the operation-receiving unit;
and when the storage-medium-recognizing unit recognizes that the storage medium is connected while the supply of electric power to the printing-executing unit is stopped in a standby state, electric power is supplied to the display unit.

3. The image forming apparatus according to claim 2, wherein when the storage-medium-recognizing unit recognizes that the storage medium is connected and electric power is supplied, the display unit performs a display prompting to set whether or not the printing-executing unit is used for a user.

4. The image forming apparatus according to claim 3, wherein
when the storage-medium-recognizing unit recognizes that the storage medium is connected,
the display unit displays files that are stored in the storage medium.

5. The image forming apparatus according to claim 4, wherein after there is a reply to an inquiring indicating that the printing-executing unit will be used, and electric power is supplied to the printing-executing unit, the printing-executing unit forms and outputs an image according to the file.

6. The image forming apparatus according to claim 2, further comprising
a document-reading unit that acquires image data by optically reading a document, and in the standby state, the supply of electric power to the document-reading unit is stopped together with the printing-executing unit; and
when there is a reply by the operation-receiving unit indicating that the printing-executing unit will not be used, electric power is set to be supplied to the document-reading unit.

7. The image forming apparatus according to claim 6, wherein the image data that is acquired after electric power is supplied to the document-reading unit is set to be stored in the storage medium.

8. The image forming apparatus according to claim 2, wherein when there is no operation to the operation-receiving unit within a preset amount of time after output from the printing-executing unit is performed after electric power is supplied to the printing-executing unit, the supply of electric power to the printing-executing unit is stopped again.

9. The image forming apparatus according to claim 8, wherein when there is no operation to the operation-receiving unit within a preset amount of time after output from the printing-executing unit is performed after electric power is supplied to the printing-executing unit, the supply of electric power to the operation-receiving unit and the display unit is stopped again.
